(19) United States
(12) Patent Application Publication
(10) Pub. No.: US 2021/0325626 A1
(43) Pub. Date: Oct. 21, 2021

(54) OPTICAL LENS AND ELECTRONIC DEVICE

(71) Applicant: HON HAI PRECISION INDUSTRY CO., LTD., New Taipei (TW)

(72) Inventors: PO-CHOU CHEN, New Taipei (TW); CHUN-CHENG KO, New Taipei (TW)

(21) Appl. No.: 16/986,472

(22) Filed: Aug. 6, 2020

(30) Foreign Application Priority Data
Apr. 16, 2020 (CN) 202010298163.8

(51) Int. Cl. G02B 7/02; G02B 13/00

(52) U.S. Cl. CPC G02B 7/022; G02B 7/021; G02B 13/0035

(57) ABSTRACT

An optical lens includes a first lens and a second lens facing the first lens. The first lens includes a first flange structure. The first flange structure includes a first surface facing the second lens. The first surface includes a first positioning portion. The second lens includes a second flange structure. The second flange structure includes a second surface facing the first lens. The second surface includes a second positioning portion. The first positioning portion engages with the second positioning portion.

### FIELD

The subject matter herein generally relates to an optical lens and an electronic device using the optical lens.

### BACKGROUND

An optical lens generally includes a lens barrel and lenses stacked in the lens barrel. Each lens includes a flange structure around the edge of the lens. Generally, the flange structure includes a smooth protrusion, and two adjacent lenses are connected by their respective protrusions. With the miniaturization of optical lenses, a thickness of the flange structure is reduced. However, a flow channel required for injection molding is also reduced, making the injection process difficult. At the same time, due to the small thickness of the flange structure, it is difficult for the injection material to completely fill the mold, resulting in a bad lens.

### BRIEF DESCRIPTION OF THE DRAWINGS

Implementations of the present disclosure will now be described, by way of embodiments, with reference to the attached figures.

FIG. 1 is a schematic cross-sectional view of an optical lens according to an embodiment of the present disclosure.

FIG. 2 is an exploded view of the optical lens shown in FIG. 1.

FIG. 3 is a schematic structural diagram of an electronic device using the optical lens.

### DETAILED DESCRIPTION

It will be appreciated that for simplicity and clarity of illustration, where appropriate, reference numerals have been repeated among the different figures to indicate corresponding or analogous elements. Additionally, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. The drawings are not necessarily to scale and the proportions of certain parts may be exaggerated to better illustrate details and features. The description is not to be considered as limiting the scope of the embodiments described herein.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The term “substantially” is defined to be essentially conforming to the particular dimension, shape, or other word that “substantially” modifies, such that the component need not be exact. For example, “substantially cylindrical” means that the object resembles a cylinder, but can have one or more deviations from a true cylinder. The term “comprising” means “including, but not necessarily limited to”; it specifically indicates open-ended inclusion or membership in a so-described combination, group, series and the like.

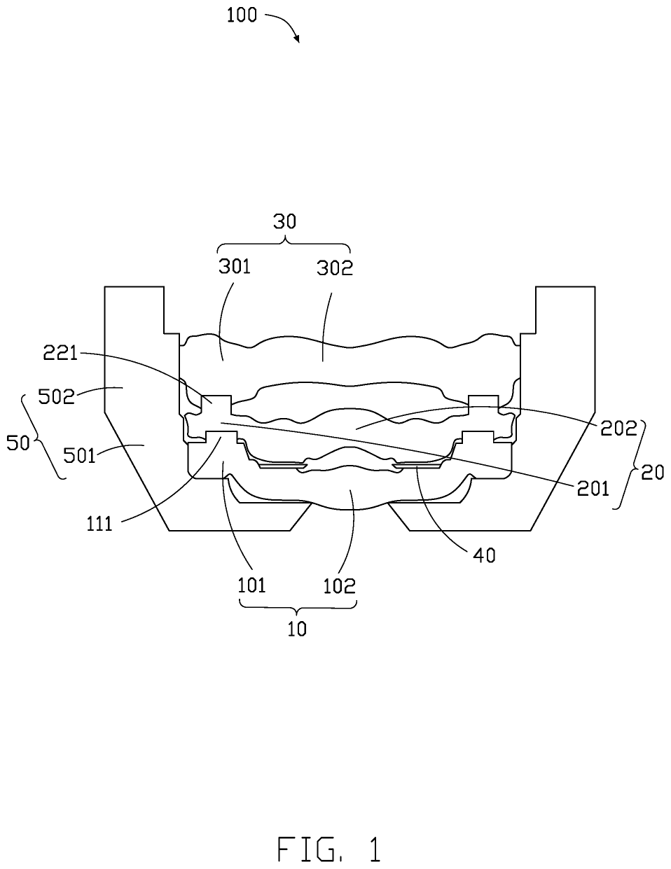

FIG. 1 shows an embodiment of an optical lens 100. The optical lens 100 includes a first lens 10, a second lens 20, and a lens barrel 50.

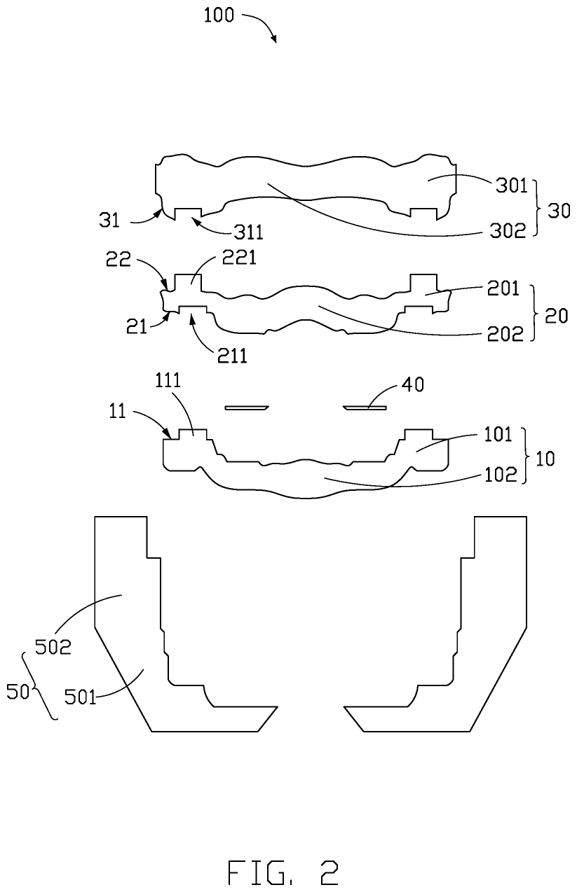

Referring to FIG. 1 and FIG. 2, the first lens 10 includes a first flange structure 101 and a first lens portion 102 connected to the first flange structure 101. The first flange structure 101 surrounds the first lens portion 102. The first flange structure 101 includes a first surface 11 facing the second lens 20, and a first positioning portion 111 is provided on the first surface 11. The first positioning portion 111 is one of a protrusion and a groove. An outer surface of the protrusion and an inner surface of the groove are smooth and flat. In one embodiment, the first positioning portion 111 is a protrusion. The rest of the first surface 11 besides the first positioning portion 111 is a rough surface.

The second lens 20 is opposite the first lens 10. The second lens 20 includes a second flange structure 201 and a second lens portion 202 connected to the second flange structure 201. The second flange structure 201 surrounds the second lens portion 202. The second flange structure 201 includes a second surface 21 facing the first lens 10 and a third surface 22 facing away from the second surface 21, and a second positioning portion 211 is provided on the second surface 21. The second positioning portion 211 is the other of the protrusion and the groove. In one embodiment, the second positioning portion 211 is a groove.

The second positioning portion 211 and the first positioning portion 111 cooperate so that the second lens 20 is disposed opposite to the first lens 10. The rest of the second surface 21 besides the second positioning portion 211 is a rough surface.

In one embodiment, the optical lens 100 further includes a third lens 30. The third lens 30 is located on a side of the second lens 20 facing away from the first lens 10. The third surface 22 is provided with a third positioning portion 221. The third lens 30 includes a third flange structure 301 and a third lens portion 302 connected to the third flange structure 301. The third flange structure 301 includes a fourth surface 31 facing the second lens 20. The fourth surface 31 is provided with a fourth positioning portion 311. The third positioning portion 221 is one of the protrusion and the groove, and the fourth positioning portion 311 is the other one of the protrusion and the groove. The third positioning portion 221 engages with the fourth positioning portion 311. In one embodiment, the third positioning portion 221 is a protrusion, and the fourth positioning portion 311 is a groove. The first lens portion 102, the second lens portion 202, and the third lens portion 302 are sequentially stacked.

It can be understood that in other embodiments, the optical lens 100 may further include a larger number of lenses. When the number of the lenses 100 exceeds three, the structure of the lenses may be similar to the first lens 10, the second lens 20, and the third lens 30. That is, each lens may include a flange structure, and each of the flange structures has protrusions or grooves, and the protrusions and grooves on the surfaces of the adjacent two lenses facing each other engage with each other.

In one embodiment, the optical lens 100 further includes a light-shielding sheet 40 located between the first flange structure 101 and the second flange structure 201. The light-shielding sheet 40 blocks stray light.

The lens barrel 50 has a substantially hollow structure. In one embodiment, the lens barrel 50 is a stepped structure. Specifically, the lens barrel 50 includes a first lens barrel portion 501 and a second lens barrel portion 502 connected to the first lens barrel portion 501. A diameter of the first lens barrel portion 501 is smaller than a diameter of the second lens barrel portion 502. The first lens barrel portion 501 and the second lens barrel portion 502 may be assembled together or integrally formed to form the lens barrel 50. A material of the lens barrel 50 may be metal or plastic.

The first lens 10, the second lens 20, and the third lens 30 are sequentially received in the lens barrel 50 along an axial direction of the lens barrel 50. Specifically, the first lens 10 is received in the first lens barrel portion 501. A portion of the second lens 20 is received in the first lens barrel portion 501, and another portion of the second lens 20 is received in the second lens barrel portion 502. The third lens 30 is received in the second lens barrel portion 502.

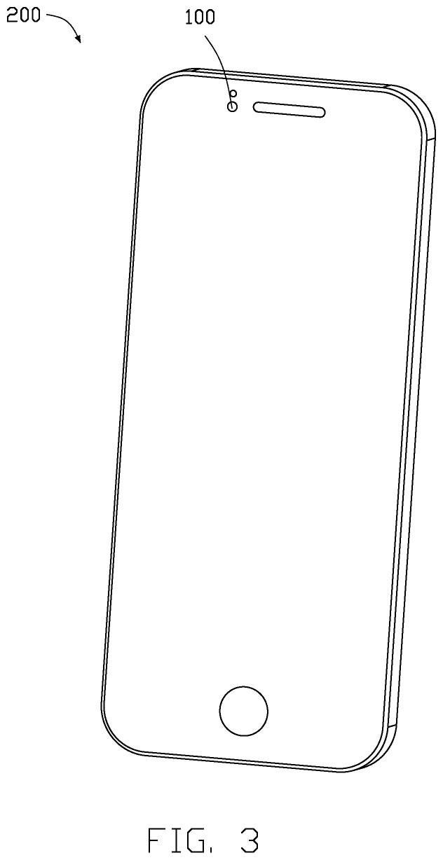

Referring to FIG. 3, the optical lens 100 can be applied to an electronic device 200, such as a mobile phone or a camera. In one embodiment, the electronic device 200 is a mobile phone.

The first positioning portion 111 and the second positioning portion 211 cooperate so that both the first flange structure 101 and the second flange structure 201 can maintain a certain thickness, thereby making the first lens 10 and the second lens 20 easy to form, thereby ensuring the quality of the first lens 10 and the second lens 20.

The embodiments shown and described above are only examples. Even though numerous characteristics and advantages of the present technology have been set forth in the foregoing description, together with details of the structure and function of the present disclosure, the disclosure is illustrative only, and changes may be made in the detail, including in matters of shape, size and arrangement of the parts within the principles of the present disclosure up to, and including, the full extent established by the broad general meaning of the terms used in the claims.

What is claimed is:

1. An optical lens comprising:
a first lens; and
a second lens facing the first lens; wherein:
the first lens comprises a first flange structure, the first flange structure comprises a first surface facing the second lens, and the first surface comprises a first positioning portion;
the second lens comprises a second flange structure, the second flange structure comprises a second surface facing the first lens, and the second surface comprises a second positioning portion; and
the first positioning portion engages with the second positioning portion.

2. The optical lens of claim 1, wherein:
the first positioning portion is one of a protrusion and a groove, and the second positioning portion is the other one of the protrusion and the groove.

3. The optical lens of claim 2, wherein:
an outer surface of the protrusion and an inner surface of the groove are flat smooth surfaces.

4. The optical lens of claim 2, wherein:
the rest of the first surface besides the first positioning portion and the rest of the second surface besides the second positioning portion are rough surfaces.

5. The optical lens of claim 1, further comprising a third lens, wherein:
the third lens is located on a side of the second lens facing away from the first lens;
the second flange structure further comprises a third surface facing away from the second surface, and the third surface comprises a third positioning portion;
the third lens comprises a third flange structure, the third flange structure comprises a fourth surface facing the second lens, and the fourth surface comprises a fourth positioning portion;
the third positioning portion is one of a protrusion and a groove, and the fourth positioning portion is the other one of the protrusion and the groove; and
the third positioning portion engages with the fourth positioning portion.

6. The optical lens of claim 1, wherein:
the first lens comprises a first lens portion coupled to the first flange structure;
the second lens comprises a second lens portion coupled to the second flange structure; and
the first lens portion and the second lens portion are opposite each other.

7. The optical lens of claim 1, further comprising a lens barrel, wherein:
the first lens and the second lens are sequentially received in the lens barrel along an axial direction of the lens barrel.

8. The optical lens of claim 7, wherein:
the lens barrel comprises a first lens barrel portion and a second lens barrel portion coupled to the first lens barrel portion;
a diameter of the first lens barrel portion is smaller than a diameter of the second lens barrel portion;
the first lens is received in the first lens barrel portion; and
a portion of the second lens is received in the first lens barrel portion, and another portion of the second lens is received in the second lens barrel portion.

9. The optical lens of claim 1, further comprising a light-shielding sheet, wherein:
the light-shielding sheet is located between the first flange structure and the second flange structure.

10. An electronic device comprising an optical lens, the optical lens comprising:
a first lens; and
a second lens facing the first lens; wherein:
the first lens comprises a first flange structure, the first flange structure comprises a first surface facing the second lens, and the first surface comprises a first positioning portion;
the second lens comprises a second flange structure, the second flange structure comprises a second surface facing the first lens, and the second surface comprises a second positioning portion; and
the first positioning portion engages with the second positioning portion.

11. The electronic device of claim 10, wherein: a
the first positioning portion is one of a protrusion and a groove, and the second positioning portion is the other one of the protrusion and the groove.

12. The electronic device of claim 11, wherein:
an outer surface of the protrusion and an inner surface of the groove are flat smooth surfaces.

13. The electronic device of claim 11, wherein:
the rest of the first surface besides the first positioning portion and the rest of the second surface besides the second positioning portion are rough surfaces.

14. The electronic device of claim 10, wherein:
the optical lens further comprises a third lens;
the third lens is located on a side of the second lens facing away from the first lens;
the second flange structure further comprises a third surface facing away from the second surface, and the third surface comprises a third positioning portion;
the third lens comprises a third flange structure, the third flange structure comprises a fourth surface facing the second lens, and the fourth surface comprises a fourth positioning portion;
the third positioning portion is one of a protrusion and a groove, and the fourth positioning portion is the other one of the protrusion and the groove; and
the third positioning portion engages with the fourth positioning portion.

15. The electronic device of claim 10, wherein:
the first lens comprises a first lens portion coupled to the first flange structure;
the second lens comprises a second lens portion coupled to the second flange structure; and
the first lens portion and the second lens portion are opposite each other.

16. The electronic device of claim 10, wherein:
the optical lens further comprises a lens barrel;
the first lens and the second lens are sequentially received in the lens barrel along an axial direction of the lens barrel.

17. The electronic device of claim 16, wherein:
the lens barrel comprises a first lens barrel portion and a second lens barrel portion coupled to the first lens barrel portion;
a diameter of the first lens barrel portion is smaller than a diameter of the second lens barrel portion;
the first lens is received in the first lens barrel portion; and
a portion of the second lens is received in the first lens barrel portion, and another portion of the second lens is received in the second lens barrel portion.

18. The electronic device of claim 10, wherein:
the optical lens further comprises a light-shielding sheet;
the light-shielding sheet is located between the first flange structure and the second flange structure.
